(19) United States
(12) Patent Application Publication
(10) Pub. No.: US 2019/0095943 A1
(43) Pub. Date: Mar. 28, 2019

(54) METHOD OF PROVIDING FAMILY BOARD SERVICE USING SMART MODULE

(71) Applicant: Innopia Technologies, Inc., Seongnam-si (KR)

(72) Inventors: Changwon KIM, Seongnam-si (KR); Dong Yoon Jang, Seongnam-si (KR)

(21) Appl. No.: 15/879,328

(22) Filed: Jan. 24, 2018

(30) Foreign Application Priority Data
Sep. 28, 2017 (KR) 10-2017-0125807

(51) Int. Cl. G06Q 30/02; H04W 76/14; H04L 29/08; G06F 13/42

(52) U.S. Cl. CPC G06Q 30/0241; G06F 13/4282; H04L 67/1095; H04W 76/14

(57) ABSTRACT

Disclosed is a family board service technology using a smart module. A method of a smart device to provide a family board service according to an embodiment may include the steps of performing, by a user terminal or a service terminal, pairing with the smart device when an app for a family board service is executed in the user terminal or the service terminal, receiving updated information from the paired user terminal or service terminal, and displaying, by a display device to which the smart device has been connected, the updated information as the family board service when the updated information is transferred to the display device.

### CROSS REFERENCE TO RELATED APPLICATION

The present application claims the benefit of Korean Patent Application No. 10-2017-0125807 filed in the Korean Intellectual Property Office on Sep. 28, 2017, the entire contents of which are incorporated herein by reference.

### BACKGROUND OF THE INVENTION

### 1. Technical Field

The following description relates to a service provision technology and to a technology for enabling a display device to operate in response to a control signal from a service terminal using a dongle device in order to provide service information to the display device.

### 2. Description of the Related Art

In a daily space, various digital screens come into use in a digital signage or digital wall form that means outdoor advertising using a digital information display (DID). Users encounter media on a digital screen while they are present in a specific space or moving.

There has recently been released a service using a home display having an information sharing purpose for various life convenience at home. To this end, a wall pad-based home monitoring and control service has been released. The service using a home display may include a method of attaching a small-sized display to a refrigerator and displaying information sharing between family members, music listening, weather, checking news, and a recipe, for example.

However, the home display method has the following disadvantages. First, a home appliance built-in product, such as the refrigerator, can be used only when home appliances including a display function are purchased. Second, the wall pad method is a built-in method for perforating the wall of a house, and it operates in conjunction with home control/monitoring infrastructure provided by a corresponding residential complex construction company or a security company in a closed manner. Third, the home display method is less flexible to be used as multiple purposes, such as a public bulletin board for family members, advertising using an in-house display, and enterprise purposes.

### PRIOR ART DOCUMENT

### Patent Document

Korean Patent Application Publication No. 10-2015-0065448, Korean Patent Application Publication No. 10-2016-0095465

### SUMMARY OF THE INVENTION

There can be provided a family board service method using an ultra-small smart device. More specifically, there can be provided a method of a smart device to output a family board service for service information to a display device coupled thereto as the smart module transmits/receives the service information to/from a service terminal through wireless pairing.

A method of a smart device to provide a family board service, including the steps of performing, by a user terminal or a service terminal, pairing with the smart device when an app for a family board service is executed in the user terminal or the service terminal, receiving updated information from the paired user terminal or service terminal, and displaying, by a display device to which the smart device has been connected, the updated information as the family board service when the updated information is transferred to the display device.

The step of performing, by the user terminal or the service terminal, pairing with the smart device when the app for the family board service is executed in the user terminal or the service terminal may include the step of pairing with the smart device when the app for the family board service is executed in the user terminal. The step of receiving the updated information from the paired user terminal or the service terminal may include the step of updating, by the service terminal, changed personal information when the changed personal information is uploaded through the app of the paired user terminal and the changed personal information is transferred to the service terminal. The step of displaying, by the display device to which the smart device has been connected, the updated information as the family board service may include the step of transferring the updated personal information to the display device and displaying the updated personal information on the display device.

The step of receiving the updated information from the paired user terminal or service terminal may include the step of receiving updated advertising content from the service terminal when the advertising content is updated in the service terminal. The step of displaying, by the display device to which the smart device has been connected, the updated information as the family board service may include the step of automatically playing back the updated advertising content depending on a state of the smart device.

The step of receiving the updated information from the paired user terminal or service terminal may include the step of receiving sensing data from the service terminal when the service terminal receives the sensing data of a sensor device operating in conjunction with the service terminal and updates the sensing data. The step of displaying, by the display device to which the smart device has been connected, the updated information as the family board service may include the step of providing environment information based on the sensing data as a family board service through the display device when the sensing data received from the service terminal is updated and the updated sensing data is transferred to the display device.

A smart device for providing a family board service may include a wireless communication unit configured to perform communication for transferring service information associated with a service terminal or user terminal to a display device by transmitting/receiving the service information when the smart device is paired with the service terminal or the user terminal, a synchronization unit configured to synchronize the service information related to the paired user terminal or the service terminal, and a front app execution unit configured to provide the service information synchronized with the user terminal or the service terminal so that the service information is displayed on the display device to which the smart device is coupled as a family board service.

The synchronization unit may perform configurations for a family board service between the user terminal or the service terminal and the smart device when an app for providing a family board service is installed or executed in the user terminal or the service terminal, may synchronize service information for the family board service in real time, and may update the service information when the service information is changed.

When a change of personal information in the user terminal is recognized, the front app execution unit may transfer the changed personal information so that the changed personal information is updated and the updated personal information is displayed on the display device as a family board service.

The front app execution unit may automatically play back updated advertising content through the display device depending on a state of the smart device when the advertising content is updated by the service terminal.

The front app execution unit may transfer sensing data when the sensing data of the sensor device operating in conjunction with the service terminal is received and updated so that the updated sensing data is displayed on the display device as a family board service.

The smart device may further include a service interoperation unit configured to operate in conjunction with the smart device when an app for a family board service is executed in the user terminal or the service terminal.

### BRIEF DESCRIPTION OF THE DRAWINGS

FIG. 1 is a diagram for illustrating an example of a network environment according to an embodiment.

FIG. 2 is a block diagram for illustrating the configuration of a smart device according to an embodiment.

FIG. 3 is a flowchart for illustrating a method of the smart device according to an embodiment to provide a personal information service as a family board service.

FIG. 4 is a flowchart for illustrating a method of the smart device according to an embodiment to provide an advertising service as a family board service.

FIG. 5 is a flowchart for illustrating a method of the smart device according to an embodiment to provide an environment information service as a family board service.

### DETAILED DESCRIPTION

Embodiments are described in detail with reference to the accompanying drawings.

An embodiment relates to a technology in which a smart device 100 receives service information from a service terminal 110 through wireless pairing and outputs a family board service for the service information to a display device to which the smart device 100 is coupled. The family board service may mean a service, such as an electronic bulletin board shared between family members at home, which always maintains an ON state at home unlike TV and displays in-house advertising or the schedule, photo and memo of a family member. An embodiment may provide a family board service focused on communication between family members and enhanced convenience without using a separate device.

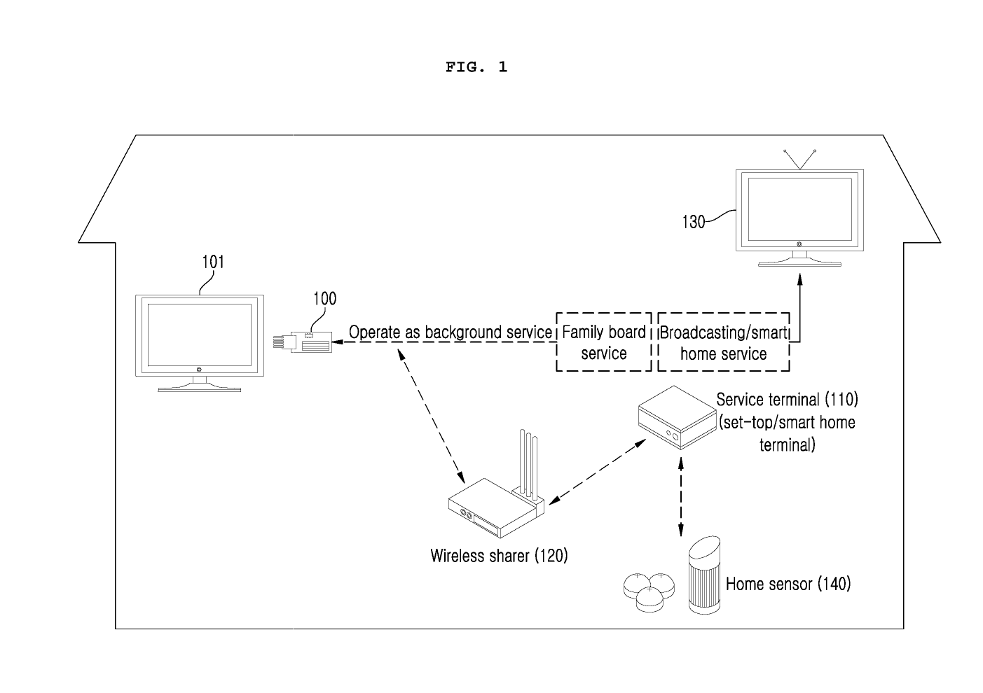

FIG. 1 is a diagram for illustrating an example of a network environment according to an embodiment.

The smart device 100 is a small device connected to a computer, such as a dongle, and means a device that is coupled to a display device and provides a family board service to the display device. The dongle is a device connected to the input/output port of a computer, and stores a security key or ID so that only a permitted user can use the dongle when a specific program is copied or executed. The dongle includes a hardware key and special key diskette used for confirmation before a program is executed and a registration number loaded onto read-only memory (ROM) upon initialization. Recently, an external peripheral device connected to a universal serial bus (USB) or HDMI port in order to support communication using a USB or Bluetooth and a media service function is called a dongle. In an embodiment, the smart device 100 is a wireless dongle supporting wireless communication and a smart media service, and may transmit or receive data to or from the service terminal 110 through wireless communication.

The smart device 100 does not have a display function, and it is plugged into a display device 101 and may transmit or receive required information to or from the service terminal 110 through wireless pairing. Accordingly, the smart device can be constructed cheaply and conveniently compared to built-in home appliances or a wall pad. Furthermore, the smart device 100 may provide a family board service using a wireless pairing method without a need for physical wiring construction.

The display device 101 may mean a monitor mounted on a wall, TV or a display device, such as an electronic picture frame. When the smart device 100 is connected to the display device 101, a family board service can be played back. For example, the display device 101 is a device operating with low energy and may be installed on a wall. The display device may be a device consuming low energy although it continues to be turned on. In this case, the display device 101 is not a device additionally installed for a family board service, but may automatically play back a family board service, such as personal information, environment information and advertising content, in the idle state in which user input is not sensed, in addition to a function performed by the display device 101.

The service terminal 110 may provide a broadcasting/smart home service and simultaneously provide a family board service. For example, the service terminal 110 may be a set-top box providing a broadcasting service. The set-top box converts an external signal and transfers it to an output device (e.g., TV) 130. The set-top box is a kind of converter which receives a digital broadcasting signal transmitted through a wired and wireless transport channel and converts the received digital broadcasting signal into a format capable of being displayed through the output device 130, such as TV. The set-top box may provide IPTV, cable TV, satellite TV or terrestrial wave TV depending on its type or may provide a plurality of media at the same time.

The service terminal 110 may operate in conjunction with the smart device 100 and does not need to be dedicated to a family board service. An app or program for providing a family board service in addition to a function of providing a broadcasting service may be installed in the service terminal 110. Accordingly, a separate service terminal 110 is not additionally installed in order to provide a family board service, but a family board service may be provided through the service terminal 110 by installing only an app or program for a family board service. In this case, the service terminal 110 provides a broadcasting/smart home service to a main service, but may drive a family board service in background.

A family board service can be provided by installing an app or program for a family board service in the smart device 100 and the service terminal 110. Furthermore, a family board service may not be provided by removing an app or program for a family board service from the smart device 100 and the service terminal 110. As described above, a service can be conveniently implemented by conveniently installing and removing an app or program for a family board service. The smart device 100 can provide a user interface for various services conveniently and intuitively through such a family board service.

A home sensor 140 determines an in-house situation through sensing data, and is a sensor device for measuring and obtaining various sensing data through the coupling of one or more sensors. For example, the home sensor 140 may measure sensing data in real time using sensors in places at home. The home sensor 140 may sense an in-house situation (environment information) by comparing the measured sensing data with previously stored sensing data. For example, the home sensor 140 may sense whether gas leaks or not, whether an entrance is open or shut, and temperature information, humidity information in each room. Furthermore, information about food stored in a refrigerator may be obtained through the home sensor 140, and management for the food may be performed. A recipe may be provided based on the information about the food stored in the refrigerator.

A wireless sharer 120 means a network device through which one or more devices share a single Internet line and access the Internet at the same time. The wireless sharer 120 is provided so that the smart device 100 and the service terminal 110 may be connected through wireless Internet.

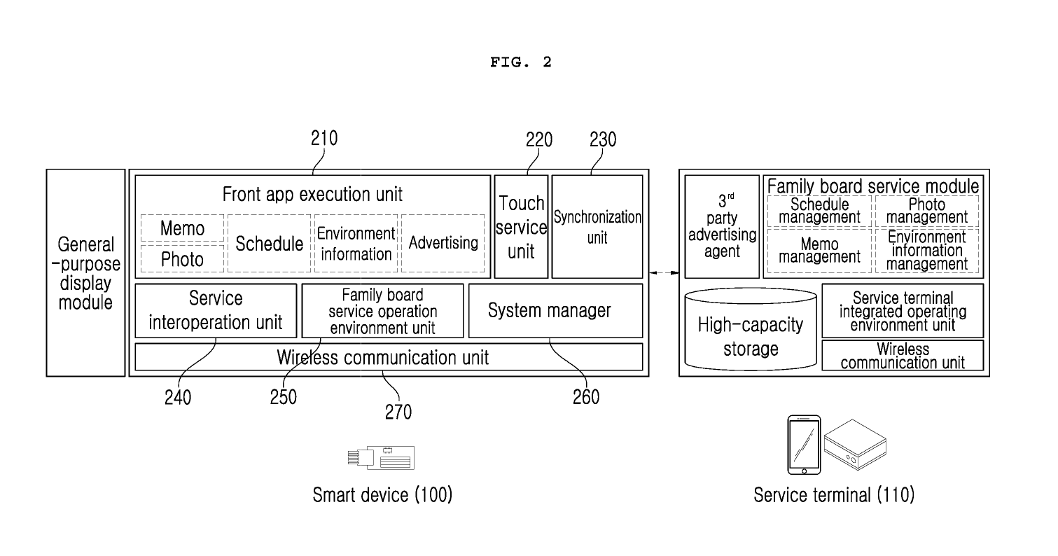

FIG. 2 is a block diagram for illustrating the configuration of a smart device according to an embodiment.

The smart device 100 provides service information, transmitted/received to/from the smart device 100 when the smart device 100 is connected to the display device present at home, as a family board service through the display device. The smart device 100 may include a front app execution unit 210, a touch service unit 220, a synchronization unit 230, a service interoperation unit 240, a family board service operation environment unit 250, a system manager 260 and a wireless communication unit 270.

The front app execution unit 210 may be provided so that the display device to which the smart device is connected displays service information, synchronized with a user terminal or the service terminal, as a family board service. When a change of personal information in the user terminal is recognized, the front app execution unit 210 may transfer the changed personal information so that it is updated and the updated personal information is displayed as a family board service through the display device. In this case, the personal information may include a memo, a photo and schedule information stored in the user terminal. Furthermore, when advertising content in the service terminal is updated, the front app execution unit 210 may automatically play back the updated advertising content through the display device depending on the state of the smart device. For example, the state of the smart device may be determined depending on whether a user input (e.g., touch) has been received by the display device coupled to the smart device. Specifically, if a user input is not present in the display device coupled to the smart device for a preset time, the smart device may determine the display device to be an idle state. Furthermore, when the sensing data of the home sensor operating in conjunction with the service terminal is received and updated, the front app execution unit 210 may transfer the updated sensing data so that the display device displays environment information based on the updated sensing data as a family board service.

The touch service unit 220 may sense a user input in the display device coupled to the smart device. For example, the touch service unit 220 may determine whether a user's touch has been input to the display device. When a user's touch is received from the user through the display device, a service based on the user's touch may be processed. In this case, when the touch service unit 220 detects no user input for a preset time and is determined to be the idle state, the smart device may automatically play back a family board service through the display device in the idle state.

The synchronization unit 230 may synchronize service information related to a paired user terminal or the service terminal. When an app for providing a family board service is installed or executed in a user terminal or the service terminal, the synchronization unit 230 may perform configurations for a family board service between the user terminal or the service terminal and the smart device, may synchronize service information for the family board service in real time, and may update service information when the service information is changed.

The service interoperation unit 240 may associate the smart device with the service terminal or a user terminal through an app for a family board service. The service interoperation unit 240 may associate the smart device with a user terminal or the service terminal when an app for a family board service is executed in the user terminal or the service terminal.

The family board service operation environment unit 250 may provide an execution environment for executing the front app execution unit providing a family board service. For example, the family board service operation environment unit 250 may provide an execution environment through a browser.

The system manager 260 may provide a function for managing the entire system platform, such as configuration information of the smart device, state information of the smart device, power and screen control.

When the smart device is paired with the service terminal or a user terminal, the wireless communication unit 270 may perform communication for transferring service information to the display device by transmitting/receiving the service information associated with the service terminal or the user terminal.

The smart device 100 does not control a family board service in the smart device 100, but includes light-weight software for decoding and transferring service information through pairing with the service terminal 110 and providing only a user input function. Accordingly, the module of the smart device itself can be implemented in an ultra-small size. In other words, the smart device 100 can be implemented as an ultra-small device because the service terminal 110 performs major processing for a family board service and the smart device 100 receives processed service information from the service terminal 110 and decodes and transfers it to the display device coupled to the smart device.

Furthermore, the service terminal 110 is a device for processing a family board service, and may include a 3^{rd} party advertising agent, a family board service module, a service terminal integrated operating environment unit, a wireless communication unit, and high-capacity storage.

The 3^{rd} party advertising agent may receive and manage external advertising content.

The family board service module may manage personal information (e.g., schedule information, photo information and memo information) of a user terminal. Furthermore, the family board service module may manage environment information based on sensing data obtained by the home sensor. In this case, the family board service module may manage the personal information of the user terminal and the environment information synthetically or individually.

The service terminal integrated operating environment unit may configure an operating environment for providing a family board service.

When wireless pairing with the smart device is performed, the wireless communication unit may transmit or receive service information associated with a family board service.

The high-capacity storage may store personal information of a user terminal, information related to content, sensing data, and environment information based on sensing data.

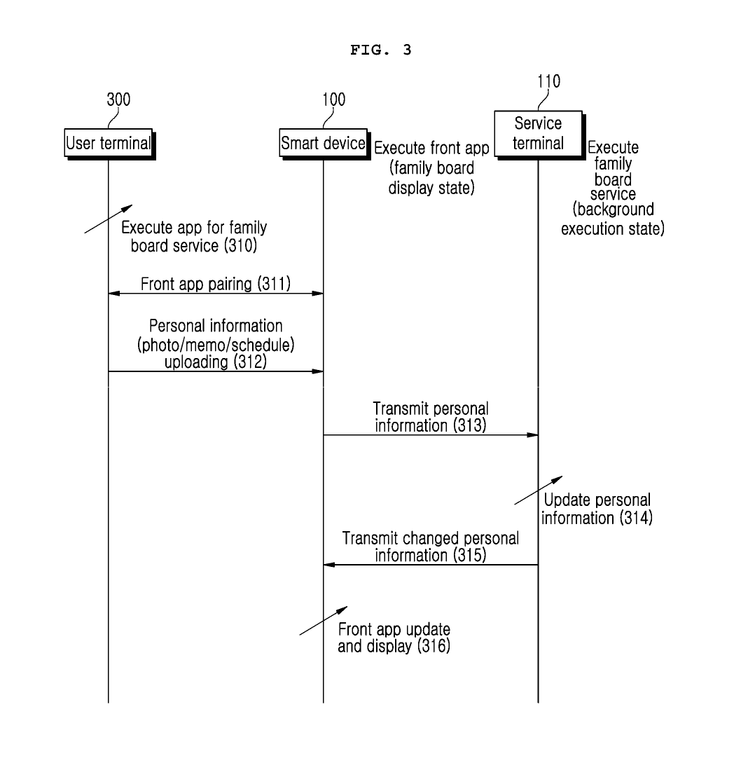

FIG. 3 is a flowchart for illustrating a method of the smart device according to an embodiment to provide a personal information service as a family board service.

Operations between the smart device 100, the user terminal 300 and the service terminal 110 for providing a personal information service as a family board service are described in detail.

The smart device 100 may have the front app being executed and remain connected to the display device. Accordingly, when the smart device 100 is connected to the display device, a family board service may be displayed on a screen of the display device. Furthermore, an app or program for a family board service may have been executed in the service terminal 110.

An app for a family board service may be executed in a user terminal 300(310). The user terminal 300 may be a fixed terminal or a mobile terminal. The user terminal may include a smart phone, a mobile phone, a navigator, a computer, a notebook, a terminal for digital broadcasting, a personal digital assistants (PDA), a portable multimedia player (PMP), and a tablet PC, for example. An app for a family board service may be installed in the user terminal 300. For example, when the app is installed in the user terminal 300, configurations for operating in conjunction with at least one in-house device may be performed. For example, an in-house device may be associated by inputting identification information (e.g., a model or device name) about each device through the app of the user terminal 300. Alternatively, when the user terminal 300 recognizes devices using the same wireless sharer, a device list may be provided and the recognized devices may be automatically associated based on the device list. Furthermore, already associated devices may be automatically connected without a subsequent separate association process.

When the app is executed in the user terminal 300, the smart device 100 may be paired with the user terminal (311). At this time, the user terminal 300 may be paired with the smart device because the front app is executed in the smart device 100. Furthermore, a family board service may be executed in the service terminal 110 because the program or app for a family board service has been installed. In this case, the service terminal 110 may additionally provide a service for a family board service in addition to a service provided by the service terminal itself. For example, the service terminal 110 may provide a main service for providing a broadcasting service and a secondary service for providing a family board service at the same time. In this case, the service terminal 110 may drive the family board service as a background service.

When the user terminal 300 and the smart device 100 are paired, the user terminal 300 may upload personal information through an app (312). For example, the personal information may mean personal information of a user, such as a memo, a photo, a moving image, document, and a schedule stored in the user terminal. Furthermore, content retrieved through the user terminal 300 may be updated as the personal information. In this case, the user terminal 300 uploads updated personal information through the app.

The smart device 100 may transmit the personal information, uploaded from the user terminal 300, to the service terminal 110 through wireless communication (313). The service terminal 110 may receive the personal information of the user terminal 300. The service terminal 110 may determine that the personal information of the user terminal 300 has changed, and may update the changed personal information of the user terminal 300 (314). In this case, a predetermined criterion for filtering the personal information of the user terminal may have been stored in the service terminal 110. For example, the service terminal 110 may set a criterion for determining whether the personal information of the user terminal is harmful information. The service terminal 110 may set the criterion according to a service provider and may set the criterion separately through an app. In this case, if the personal information of the user terminal includes harmful information (e.g., abuses and adult information), the service terminal 110 may not permit the personal information of the user terminal. If the changed personal information of the user terminal includes harmful information, the service terminal 110 may not transfer the changed personal information of the user terminal to the smart device 100. If the changed personal information of the user terminal does not include harmful information, the service terminal 110 may transmit the changed personal information of the user terminal to the smart device 100 (315). As described above, the smart device 100 does not directly transfer personal information of the user terminal to the display device, and harmful information can be prevented from leaking to a family board service through a permission process according to the service terminal 110. Accordingly, the security of a family board service can be improved.

The smart device 100 may receive the changed personal information from the service terminal 110. The smart device 100 may update the front app with the changed personal information, and may provide the changed personal information as a family board service through the front app. The smart device 100 may transfer the changed personal information to the display device to which the smart device 100 has been connected through the front app, and may display the changed personal information on the display device as a family board service (316).

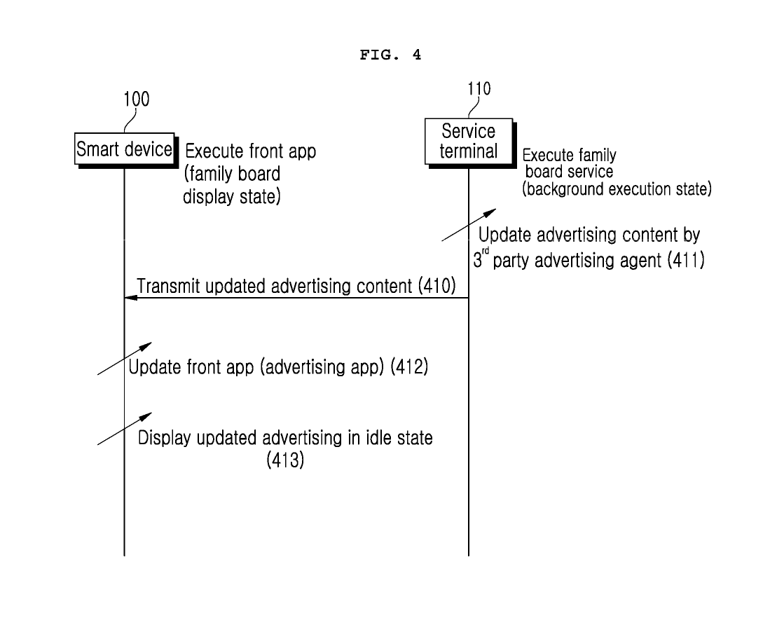

FIG. 4 is a flowchart for illustrating a method of the smart device according to an embodiment to provide an advertising service as a family board service.

An operation between the smart device 100 and the service terminal 110 for providing an advertising service as a family board service is described in detail.

The smart device 100 may have the front app being executed and remain connected to the display device. Accordingly, when the smart device 100 is connected to the display device, a family board service may be displayed on a screen of the display device. Furthermore, an app or program for a family board service may have been executed in the service terminal 110. At this time, the service terminal 110 may execute the family board service in a background execution state.

The service terminal 110 may update advertising content by the 3^{rd} party advertising agent (411). In this case, an embodiment is not limited to the advertising content and may include various types of content in addition to the advertising content. In FIG. 4, advertising content is described as an example. More specifically, the service terminal 110 may receive the advertising content from an external advertising server. When the service terminal 110 receives the advertising content, it may update the 3^{rd} party advertising agent with the received advertising content.

The service terminal 110 may transmit the updated advertising content to the smart device 100 (410). The smart device 100 may update the front app with the advertising content received from the service terminal 110 (412). The smart device 100 may automatically play back the updated advertising content depending on the state of the smart device. For example, the state of the smart device 100 may include a sleep state, an idle state, and a wake-up state.

In the idle state, the smart device 100 may update the front app with the updated advertising content and provide the changed advertising content through the front app as a family board service. In the idle state, the smart device 100 may transfer the updated advertising content to the display device to which the smart device 100 is connected through the front app, and may display the changed advertising content on the display device may display as a family board service (413). Accordingly, the updated advertising content may be automatically played back in the display device.

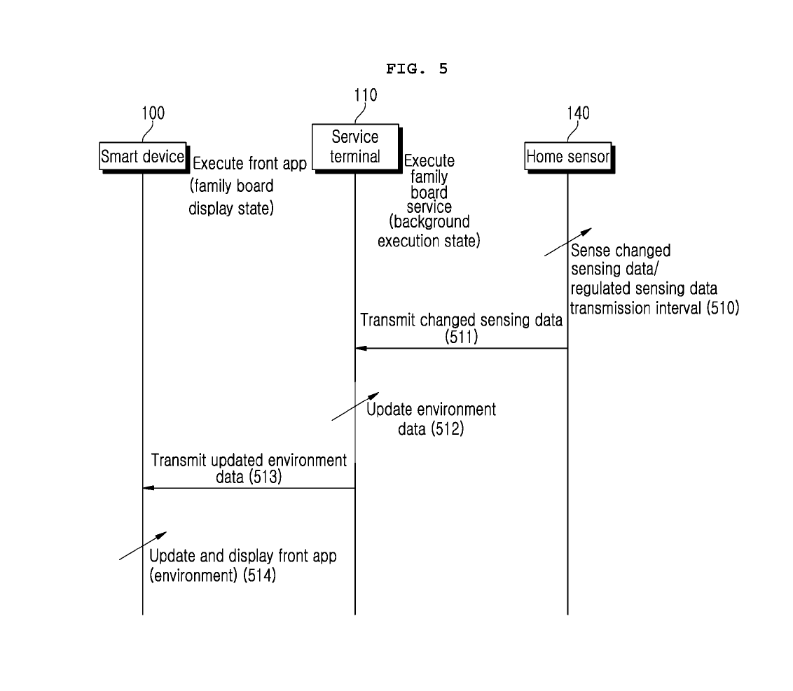

FIG. 5 is a flowchart for illustrating a method of the smart device according to an embodiment to provide an environment information service as a family board service.

Operations between the smart device 100, the service terminal 110 and the home sensor 140 for providing an environment information service as a family board service are described in detail.

The smart device 100 may have the front app being executed and remain connected to the display device. Accordingly, when the smart device 100 is connected to the display device, a family board service may be displayed on a screen of the display device. Furthermore, the app or program for a family board service may have been executed in the service terminal 110. In this case, the service terminal 110 may execute the family board service in the background execution state.

The home sensor 140 may operate in conjunction with the service terminal 110. The home sensor 140 may obtain in-house sensing data and sense changed sensing data (510). The home sensor 140 may obtain the sensing data periodically (i.e., at specific intervals) or periodically. For example, the home sensor 140 may periodically measure sensing data. If a change of sensing data is sensed periodically, the home sensor 140 may measure the sensing data.

The home sensor 140 may transmit the changed sensing data to the service terminal 110(511). The service terminal 110 may receive the sensing data from the home sensor 140. The service terminal 110 may update environment information based on the changed sensing data (512).

The service terminal 110 may transmit the updated environment information to the smart device 100 (513). The smart device 100 may receive the updated environment information from the service terminal 110. The smart device 100 may update the front app with the changed environment information and transmit the changed environment information as a family board service through the front app. The smart device 100 may transfer the changed environment information to the display device to which the smart device 100 has been connected through the front app. The changed environment information may be displayed on the display device as a family board service (514). Accordingly, the environment information may be displayed on the display device as a family board service.

The smart device according to an embodiment transfers service information transmitted/received to/from the service terminal to the display device when it is coupled to the display device. Accordingly, service information, such as personal information including schedule information, a memo, and a photo, content, and environment information, can be displayed on the display device as a family board service.

The smart device according to an embodiment can be used conveniently by installing and removing an app for a family board service, and can provide a convenient and intuitive user interface for various services.

The smart device according to an embodiment does not control a family board service, but includes light-weight software for displaying service information through wireless pairing with the service terminal and providing a user input function only. Accordingly, the module of the smart device can be implemented in an ultra-small size.

The apparatus described above may be implemented in the form of a combination of hardware components, software components, and/or hardware components and software components. For example, the apparatus and components described in the embodiments may be implemented using one or more general-purpose computers or special-purpose computers, for example, a processor, a controller, an arithmetic logic unit (ALU), a digital signal processor, a microcomputer, a field programmable array (FPA), a programmable logic unit (PLU), a microprocessor or any other device capable of executing or responding to an instruction. A processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may be aware that the processing device may include a plurality of processing elements and/or a plurality of types of processing elements. For example, the processing device may include a plurality of processors or a single processor and a single controller. Furthermore, other processing configuration, such as a parallel processor, is also possible.

Software may include a computer program, code, an instruction or one or more combinations of them and may configure the processing device so that it operates as desired or may instruct the processing device independently or collectively. Software and/or data may be interpreted by the processing device or may be embodied in a machine, component, physical device, virtual equipment or computer storage medium or device of any type or a transmitted signal wave permanently or temporarily in order to provide an instruction or data to the processing device. Software may be distributed to computer systems connected over a network and may be stored or executed in a distributed manner. Software and data may be stored in one or more computer-readable recording media.

The method according to an embodiment may be implemented in the form of a program instruction executable by various computer means and stored in a computer-readable recording medium. The computer-readable recording medium may include a program instruction, a data file, and a data structure solely or in combination. The program instruction recorded on the recording medium may have been specially designed and configured for the embodiment or may be known to those skilled in computer software. The computer-readable recording medium includes a hardware device specially configured to store and execute the program instruction, for example, magnetic media such as a hard disk, a floppy disk, and a magnetic tape, optical media such as CD-ROM or a DVD, magneto-optical media such as a floptical disk, ROM, RAM, or flash memory. Examples of the program instruction may include both machine-language code, such as code written by a compiler, and high-level language code executable by a computer using an interpreter.

Although the embodiments have been described in connection with the limited embodiments and the drawings, a person having ordinary skill in the art may modify and change the above description in various manners. For example, proper results may be achieved although the aforementioned description is performed in order different from that of the described method and/or the aforementioned elements, such as a system, configuration, device, and circuit, are coupled or combined in a form different from that of the described method or replaced or substituted with other elements or equivalents.

Accordingly, other implementations, other embodiments, the claims and equivalents thereof belong to the scope of the claims.

What is claimed is:

1. A method of a smart device to provide a family board service, comprising steps of:
performing, by a user terminal or a service terminal, pairing with the smart device when an app for a family board service is executed in the user terminal or the service terminal;
receiving updated information from the paired user terminal or service terminal; and
displaying, by a display device to which the smart device has been connected, the updated information as the family board service when the updated information is transferred to the display device.

2. The method of claim 1, wherein:
the step of performing, by the user terminal or the service terminal, pairing with the smart device when the app for the family board service is executed in the user terminal or the service terminal comprises a step of pairing with the smart device when the app for the family board service is executed in the user terminal,
the step of receiving the updated information from the paired user terminal or the service terminal comprises a step of updating, by the service terminal, changed personal information when the changed personal information is uploaded through the app of the paired user terminal and the changed personal information is transferred to the service terminal, and
the step of displaying, by the display device to which the smart device has been connected, the updated information as the family board service comprises a step of transferring the updated personal information to the display device and displaying the updated personal information on the display device.

3. The method of claim 1, wherein:
the step of receiving the updated information from the paired user terminal or service terminal comprises a step of receiving updated advertising content from the service terminal when the advertising content is updated in the service terminal, and
the step of displaying, by the display device to which the smart device has been connected, the updated information as the family board service comprises a step of automatically playing back the updated advertising content depending on a state of the smart device.

4. The method of claim 1, wherein:
the step of receiving the updated information from the paired user terminal or service terminal comprises a step of receiving sensing data from the service terminal when the service terminal receives the sensing data of a sensor device operating in conjunction with the service terminal and updates the sensing data, and
the step of displaying, by the display device to which the smart device has been connected, the updated information as the family board service comprises a step of providing environment information based on the sensing data as a family board service through the display device when the sensing data received from the service terminal is updated and the updated sensing data is transferred to the display device.

5. A smart device for providing a family board service, comprising:
a wireless communication unit configured to perform communication for transferring service information associated with a service terminal or user terminal to a display device by transmitting/receiving the service information when the smart device is paired with the service terminal or the user terminal;
a synchronization unit configured to synchronize the service information related to the paired user terminal or the service terminal; and
a front app execution unit configured to provide the service information synchronized with the user terminal or the service terminal so that the service information is displayed on the display device to which the smart device is coupled as a family board service.

6. The smart device of claim 5, wherein the synchronization unit performs configurations for a family board service between the user terminal or the service terminal and the smart device when an app for providing a family board service is installed or executed in the user terminal or the service terminal, synchronizes service information for the family board service in real time, and updates the service information when the service information is changed.

7. The smart device of claim 5, wherein when a change of personal information in the user terminal is recognized, the front app execution unit transfers the changed personal information so that the changed personal information is updated and the updated personal information is displayed on the display device as a family board service.

8. The smart device of claim 5, wherein the front app execution unit automatically plays back updated advertising content through the display device depending on a state of the smart device when the advertising content is updated by the service terminal.

9. The smart device of claim 5, wherein the front app execution unit transfers sensing data when the sensing data of the sensor device operating in conjunction with the service terminal is received and updated so that the updated sensing data is displayed on the display device as a family board service.

10. The smart device of claim 5, further comprising a service interoperation unit configured to operate in conjunction with the smart device when an app for a family board service is executed in the user terminal or the service terminal.
